(19) United States
(12) Patent Application Publication
(10) Pub. No.: US 2014/0379725 A1
(43) Pub. Date: Dec. 25, 2014

(54) ON DEMAND PARALLELISM FOR COLUMNSTORE INDEX BUILD

(71) Applicant: Microsoft Corporation, Redmond, WA (US)

(72) Inventors: In-Jerng Choe, Sammamish, WA (US); Mayukh Saubhasik, Sammamish, WA (US); Ashit Gosalia, Sammamish, WA (US); Srikumar Rangarajan, Sammamish, WA (US)

(73) Assignee: Microsoft Corporation, Redmond, WA (US)

(21) Appl. No.: 14/138,960

(22) Filed: Dec. 23, 2013

Related U.S. Application Data
(60) Provisional application No. 61/837,086, filed on Jun. 19, 2013.

(51) Int. Cl. G06F 17/30; G06F 9/50

(52) U.S. Cl. CPC G06F 17/30321; G06F 9/50
USPC 707/741; 718/104

(57) ABSTRACT

The degree of parallel processing used to build a database index can be dynamically adjusted based on actual memory usage of individual parallel processing units. Memory can be reserved to prevent an out-of-memory condition. A predetermined number of initial parallel processing units can be activated. The actual usage of resources by the initial activated parallel processing unit(s) can be measured to establish an initial baseline for resource consumption per parallel processing unit. The baseline for resource consumption per parallel processing unit can be used to determine how many additional parallel processing units are activated. The actual resource usage of each parallel processing unit can be measured and used to refine the baseline memory usage. The refined average memory usage can be used to determine how many additional parallel processing units are activated.

### CROSS-REFERENCE TO RELATED APPLICATIONS

This application claims the benefit of U.S. Provisional Application No. 61/837,086 entitled “ON DEMAND PARALLELISM FOR COLUMNSTORE INDEX BUILD” filed on Jun. 19, 2013 which is hereby incorporated by reference in its entirety.

### BACKGROUND

The term “database” is generally used to refer to a collection of organized information in a regular structure, usually in rows and columns The term includes both the data itself and the supporting data structures. A database as the term is used herein is in a machine-readable format accessible by a computer. A data warehouse is a large repository of data stored in a database used for reporting and data analysis. A data warehouse can be created by integrating data from one or more sources. Because of the volume of data, processing to get an aggregated, grouped or filtered view is typically very CPU (central processing unit) and memory intensive. A database management system (DBMS) is a suite of computer software that interfaces between users and one or more databases.

A database index improves the speed of data retrieval operations on a database or data warehouse. A rowstore index can be created by using one or more columns of a database table which can enable faster random lookups and more efficient access of ordered records. An index can be a copy of a part of a table. Some databases allow creation of indices on functions or expressions (e.g., only storing the upper case version of a last name field in the index). A “filtered” index is one in which an index entry is created only for records that satisfy some conditional expression. An index can be created from a user-defined function or from an expression formed from a built-in function.

### SUMMARY

The degree of parallel processing used for an application can be dynamically (i.e., while the application is running) adjusted by measuring the amount or number of resources utilized by parallel processing units. The resources can be processing resources, memory, and/or input/output, for example. The amount/number of resources used by a specified number of initial parallel processing units can be used as a baseline resource utilization to determine how many additional parallel processing units the resources of a computing device can support. The amount/number of resources used by the initial parallel processing unit(s) can be used as a baseline resource utilization to determine how many additional parallel processing units are activated.

The determined number of additional parallel processing units can be activated. Each parallel processing unit can require the same resources. The resources required by a parallel processing unit may differ from the resources required by or requested by other parallel processing units. A parallel processing unit may request an amount/number of resources. Each parallel processing unit can request the same resources. The resources requested by a parallel processing unit may differ from the resources required by or requested by other parallel processing units. The actual amount/number of resources utilized by each activated parallel processing unit can be measured. As each parallel processing unit completes, the baseline resource utilization can be updated in accordance with a computation that is derived from the measured actual resources used. The updated resource utilization can be used to determine how many additional parallel processing units can be activated. Thus, the number of activated parallel processing units and therefore the degree of parallelism can change during the execution of the application, automatically (by operation of a computer program) without user intervention. Degree of parallelism refers to the number of activated parallel processing units concurrently executing the application. The degree of parallelism employed in execution of an application can adjust to changing resource availability, changing characteristics of the data processed and/or changing processing characteristics.

The degree of parallel processing used to build an index for a database can be dynamically adjusted based on actual observation of building a segment of the index. When building an index for a database, a portion of available resources (e.g., a portion of memory) can be reserved before execution of the application begins. The reserved resources can be a maximum amount/number of resources that can be allocated per query in preparation for a maximum degree of parallel processing of the index. The reserved resources can be a user-defined amount/number of resources that can be allocated per query in preparation for a user-defined degree of parallel processing of the index. In some cases, a number of parallel processing units (e.g., threads) can be started for parallel processing of the index and suspended. The number of parallel processing units that are started and suspended can be a specified number of parallel processing units. The number of parallel processing units that are started and suspended can be a maximum number of parallel processing units that can be started, depending on the number of available CPUs and/or other resources.

In some cases, all parallel processing units can be suspended at startup except for a specified number of initial parallel processing units. Alternatively, a specified number of initial parallel processing units can be initialized and activated. A single activated parallel processing unit can, for example, be used to build one segment of an index. That is, a segment of an index can be an index for a configurable number of rows (e.g., the index for a million rows comprises the segment of the index that is built). The segment built by an activated parallel processing unit can be the segment of the index for some other specifiable portion of the database. The activated parallel processing units can be allowed to use all or part of the reserved resources. The activated parallel processing units can be allowed to use all or part of the reserved memory, so that an out-of-memory condition becomes unlikely. The actual usage of resources by the initial activated parallel processing unit(s) can be measured to establish a baseline resource utilization per parallel processing unit. Using the baseline resource utilization per parallel processing unit, the number of parallel processing units (e.g., threads) activated can be the number of parallel processing units supported by the reserved resources. The number of parallel processing units activated can be determined by a computation based on the value of the baseline resource utilization.

The actual resource usage of each parallel processing unit can be measured when each parallel processing unit completes (e.g., at the completion of building a segment of the index). Each time a segment of the index is successfully created, the actual resource usage for the segment creation can be used to update the baseline resource consumption per parallel processing unit. The updated baseline resource usage can be used to determine how many parallel processing units are activated. The described activate, measure and resource usage updating paradigm can be continued until the building of the index is completed. Building of the index can react to non-uniform data distribution by increasing or decreasing the degree of parallelism. Each parallel processing unit can run without affecting any other parallel processing unit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 101 that dynamically adjusts the degree of parallelism employed by an application in accordance with aspects of the subject matter described herein;

FIG. 1b illustrates an example of a system 100 that dynamically adjusts the degree of parallelism employed for building an index for a database in accordance with aspects of the subject matter described herein;

FIG. 2a illustrates an example of a method 250 that dynamically adjusts the degree of parallelism employed by an application in accordance with aspects of the subject matter disclosed herein;

FIG. 2b illustrates an example of a method 200 that dynamically adjusts the degree of parallelism employed for building an index for a database in accordance with aspects of the subject matter disclosed herein;

FIG. 3 is a block diagram of an example of a computing environment in accordance with aspects of the subject matter disclosed herein.

### DETAILED DESCRIPTION

### Overview

The growth of data warehousing, decision support and business intelligence applications has created a desire to quickly read large data sets and to process them to produce useful information. To address this desire, the concept of a columnstore index evolved. A columnstore index groups and stores data for each column. The columns are joined to create the index. This approach differs from that of a traditional index. A traditional index groups and stores data for each row and then joins all the rows to complete the index. For some types of queries, the columnstore layout can be used to improve filtering, aggregating, grouping, and star-join query execution times.

Unlike the traditional row based organization of data (called rowstore format), in columnar database systems such as but not limited to Microsoft's SQL Server® with columnstore indexes, data is grouped and stored one column at a time. Columnstore indexes can produce faster results because only the relevant columns have to be read. Less data is read from disk to memory and later, less data is moved from memory to processor cache. In addition, columnstore indexes can produce faster results because columns are compressed, reducing the number of bytes that have to be read and moved. Columnstore indexes can produce faster results because most queries do not touch all columns of the table so many columns will never be brought into memory, which in combination with compression, improves buffer pool usage, and therefore reduces total input/output operations (I/O).

Columnstore indexes can produce faster results because advanced query execution technology processes batches of columns reducing CPU and I/O usage. Columnstore indexes can produce faster results because there is no concept of key columns so the limitation on the number of key columns in an index does not apply to columnstore indexes. If columns are not listed in the create index statement, they will be added to the columnstore index automatically. Columnstore indexes can produce faster results because columnstore indexes works with table partitioning without changing the table partitioning syntax. A columnstore index on a partitioned table has to be partition-aligned with the base table. Therefore, a columnstore index can only be created on a partitioned table if the partitioning column is one of the columns in the columnstore index. Columnstore indexes can produce faster results because the index key record size limitation of 900 bytes does not apply to columnstore indexes. Columnstore indexes can produce faster results because batch processing is used to take advantage of the columnar orientation of the data.

In accordance with aspects of the subject matter described herein, the degree of parallel processing used for an application (e.g., to build a database index) can be dynamically adjusted based on actual resource usage of individual parallel processing units. Resources for parallel processing can be reserved. Memory can be reserved to prevent an out-of-memory condition. A predefined number of parallel processing units can be activated. The activated parallel processing unit(s) can be used to execute a portion of the application (e.g., to build one or more segments of the index). The actual usage of resources by the activated parallel processing unit can be measured to establish a baseline resource utilization per parallel processing unit. The baseline resource utilization per parallel processing unit can be used to determine how many additional parallel processing units (e.g., threads) are activated. The actual resource usage of each parallel processing unit can be measured and used to update the baseline resource utilization. The updated baseline resource utilization can be used to determine how many parallel processing units are activated. The suspension and activation of the parallel processing units can be done transparently using a gating mechanism so that the end result: (e.g., building a complete index) using an optimal number of parallel processing units is equivalent whether all or some of parallel processing units run concurrently. Activating too many parallel processing units can result in each of the units encountering a low memory condition, in which case the index segment being created may be truncated.

### On Demand Parallelism for Columnstore Index Build

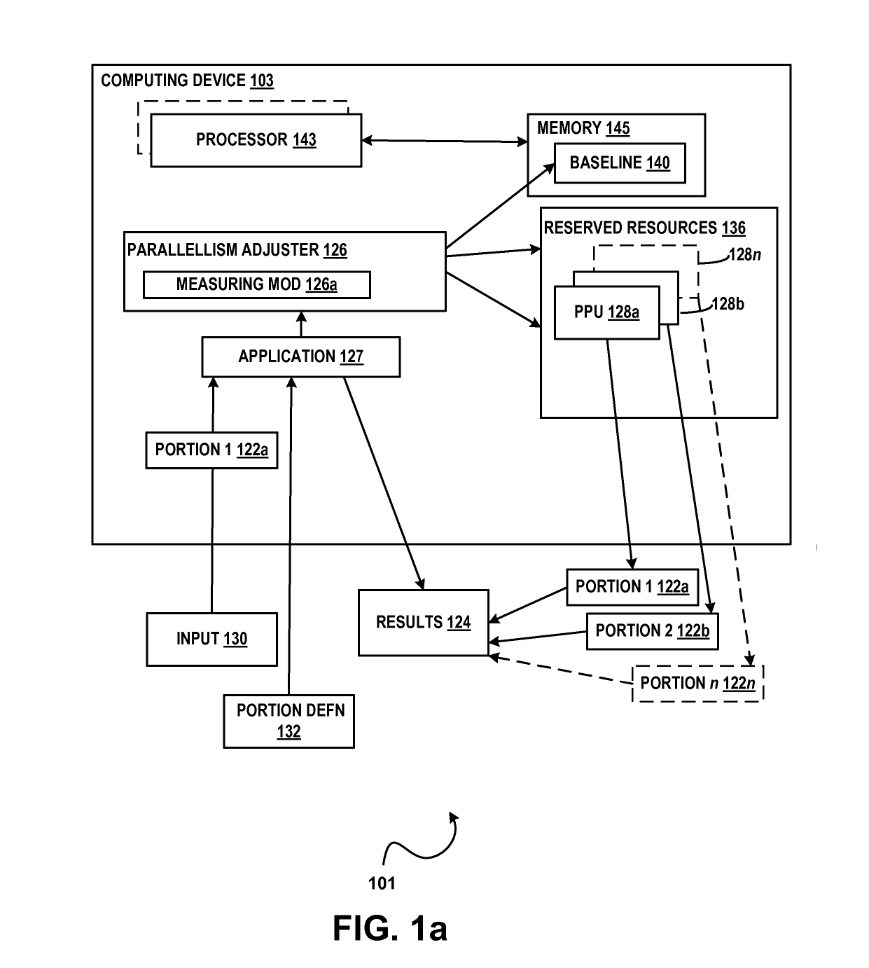

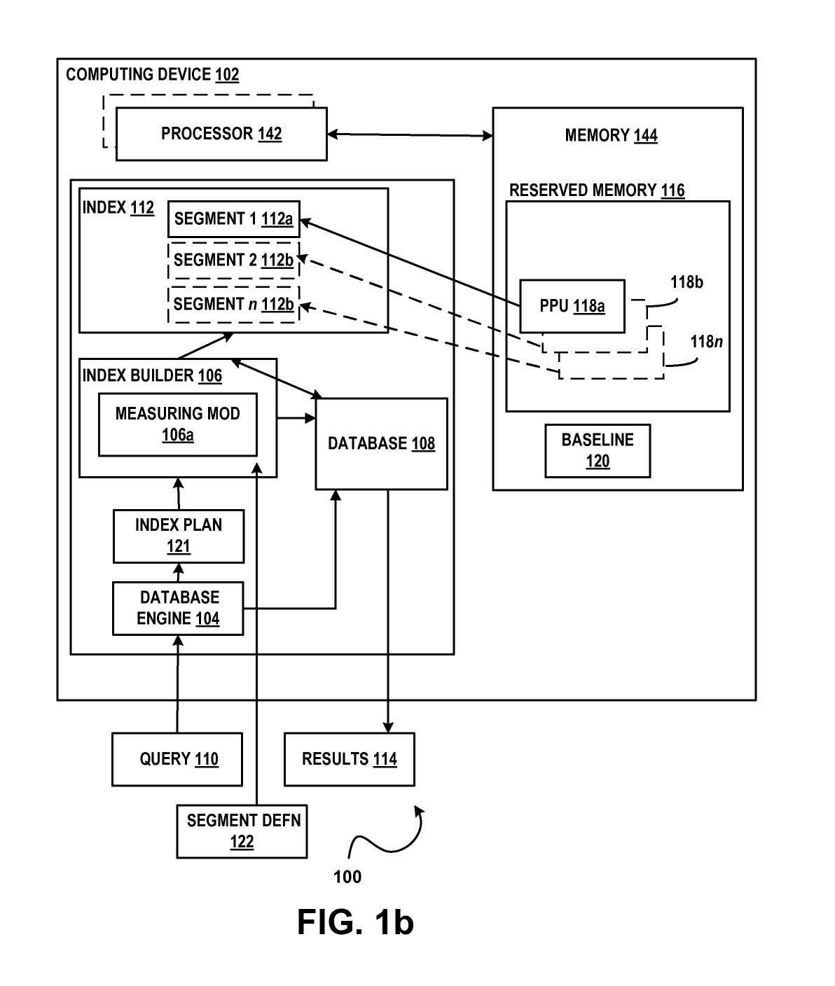

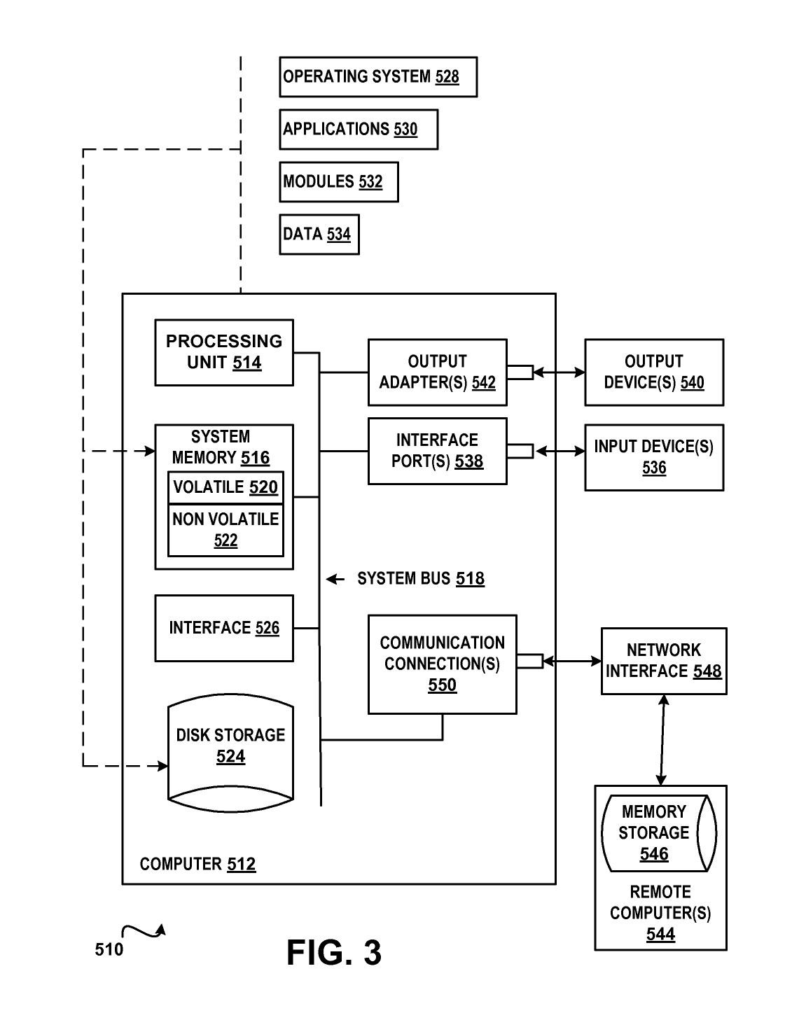

FIG. 1a illustrates a block diagram of an example of a system 101 that dynamically adjusts the degree of parallelism employed by an application in accordance with aspects of the subject matter described herein. All or portions of system 101 may reside on one or more computers or computing devices such as the computers described below with respect to FIG. 3. System 101 or portions thereof may be provided as a stand-alone system or as a plug-in or add-in. System 101 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 101 can include one or more computing devices such as, for example, computing device 103. A computing device such as computing device 103 can include one or more processors such as processor 143, etc., and a memory such as memory 145 connected to the one or more processors. System 101 can include one or more of the following: an application that can employ parallel processing, and one or more program modules comprising a parallelism adjuster such as parallelism adjuster 126. Parallelism adjuster 126 can include one or more program modules comprising a parallelism adjuster measurer such as parallelism adjuster measuring module 126a. System 101 can include one or more components or program modules comprising: an application such as application 127, input such as input 130, and/or a portion definition such as portion definition 132. System 101 can produce results such as results 124, which can include one or more portions such as portion, portion 1 122a, portion 2 122b . . . portion n 122n. System 101 can also include other components known in the art (not shown).

In operation an application such as application 127 can be initiated. An application 127 can be any application capable of employing parallel processing. Input 130 provided to application 127 can be any data on which the application 127 operates. In accordance with some aspects of the subject matter disclosed herein, input 130 is data that is not uniform. Parallelism adjuster 126 can receive a portion definition such as portion definition 132. A portion definition can define how the application can be broken into parallel processing units. Portion definition 132 can be received as user input, as information stored with the application 127 or by any other means. In accordance with some aspects of the subject matter described herein, the parallelism adjuster 126 can change the portion definition in accordance with rules provided for the portion definition with respect to the degree of parallelism achievable with that portion definition.

Parallelism adjuster 126 can reserve resources (e.g., reserved resources 136) for the parallel processing units. The amount of resources reserved can be the maximum allowed resources for the application. The maximum amount of resources that can be reserved can be determined by a configurable setting for the computing device, a user-defined amount of resources, by a computation derived from the amount of resources of the computing device(s) or by any other method. A single parallel processing unit such as parallel processing unit 128a can be activated. A single parallel processing unit can be but is not limited to a single thread. Parallel processing unit 128a can generate a specified portion of the results 124 of executing the application 127 such as portion 1 122a. Subsequently activated parallel processing units may generate addition portions of the results. For example, a second parallel processing unit such as parallel processing unit 128b may generate a second portion of the results such as portion 2 122b and so on to parallel processing unit 128n and portion n 122n. In the event that a parallel processing unit starts to run low on memory (i.e., an out-of-memory condition occurs or is likely to occur), all or some additional memory of reserved memory resources can be provided to the parallel processing unit.

The actual amount of resources that are used by a specified number of activated parallel processing units (e.g., parallel processing unit 128a, etc.) can be measured by one or more program modules, represented in FIG. 1a by measuring module 126a. The actual amount of resources that are used by one parallel processing unit can be used to determine a baseline of resource usage for future parallel processing units. Suppose the specified number of initially activated parallel processing units is a single parallel processing unit, parallel processing unit 128a. Suppose reserved resources 136 includes eleven kilobytes (KB) of memory and that parallel processing unit 128a used two KB of memory when it executed. That would mean that with respect to memory resources, a total of five parallel processing units can be activated concurrently and one KB of memory is available for various uses. Parallelism adjuster 126 can activate the computed number of parallel processing units (e.g., parallel processing unit 128b, etc.).

The actual resource usage of each of the activated parallel processing units (e.g., parallel processing unit 128b, etc.) can be measured by measuring module 126a. As each parallel processing unit completes its portion of execution of the application 127, measuring module 126a can update the baseline resource utilization of all completed parallel processing units according to some computation. For example, suppose the resource in question is memory. Suppose parallel processing unit 128a completes building portion 1 122a of results 124 and has used two KB of memory. Suppose the computation determines that the current baseline resource utilization is two. Five additional parallel processing units can be activated. Suppose that the second parallel processing unit completes and used three KB of memory. Suppose the computation determines that the current baseline resource utilization is 2.5 units. The reserved memory of 11 units only supports four activated parallel processing units. Four parallel processing units are running so a new one is not activated until one of the four executing parallel processing units finishes. The process described above can continue until execution of application 127 completes. The current baseline resource utilization can be stored in memory (e.g., baseline 140).

FIG. 1b illustrates a block diagram of an example of a system 100 in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in. System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102. A computing device such as computing device 102 can include one or more processors such as processor 142, etc., and a memory such as memory 144 connected to the one or more processors.

System 100 can include one or more of the following: a database engine such as database engine 104, and an index builder such as index builder 106. Index builder 106 can be incorporated into the database engine (not shown) or can be separate from the database engine. Database engine 104 may operate on a database such as database 108. Database 108 can be a relational database, a hierarchical database, a data warehouse or any other type of machine-readable database. A database engine 104 may receive a database query such as database query 110. Database engine 104 can be a SQL DBMS, a Oracle Database, an IBM DB2) or any other kind of DBMS. A database query 110 is a precise request for information retrieval. A database query 110 is typically written in a query language, a computer language used to make queries into databases and information systems.

Common query languages include but are not limited to .QL, a proprietary object-oriented query language for querying relational databases; Contextual Query Language (CQL), a formal language for representing queries to information retrieval systems such as web indexes or bibliographic catalogues; CQLF (CODASYL Query Language, Flat), a query language for CODASYL-type databases; Concept-Oriented Query Language (COQL), used in the concept-oriented model based on a data modeling construct, using projection and de-projection operations for multi-dimensional analysis, analytical operations and inference; D, a query language for truly relational database management systems (TRDBMS); DMX, a query language for Data Mining models; Datalog, a query language for deductive databases; Gellish English, a language that can be used for queries in Gellish English Databases for dialogues (requests and responses) and/or for information modeling and knowledge modeling; HTSQL a query language that translates HTTP queries to SQL; ISBL, a query language for PRTV, a relational database management system; and LINQ query-expressions that query various data sources from .NET languages.

Additional query languages include LDAP, an application protocol for querying and modifying directory services running over TCP/IP; MQL, a cheminformatics query language for a substructure search allowing nominal and numerical properties; MDX, a query language for OLAP databases; OQL, an Object Query Language; OCL (Object Constraint Language), an object query language and an OMG standard; OPath, intended for use in querying WinFS Stores; OttoQL, intended for querying tables, XML, and databases; Poliqarp Query Language, a query language designed to analyze annotated text used in the Poliqarp search engine; QUEL, a relational database access language; RDQL, a RDF query language; Slick, a data query framework that provides a way to query various data sources from the Scala programming language; SMARTS, a cheminformatics standard for a substructure search; SPARQL, a query language for RDF graphs; SPL, a search language for machine-generated big data based upon Unix Piping and SQL; SQL, a query language and Data Manipulation Language for relational databases; SuprTool, a proprietary query language for SuprTool, a database access program used for accessing data in Image/SQL (formerly TurboIMAGE) and Oracle databases; TMQL (Topic Map Query Language), a query language for Topic Maps; TSQL (Transact-SQL), a proprietary extension to SQL; UnQL (Unstructured Query Language), a functional superset of SQL; XQuery, a query language for XML data sources; XPath, a declarative language for navigating XML documents; XSPARQL, an integrated query language combining XQuery with SPARQL to query both XML and RDF data sources at once; YQL, a query language created by Yahoo!.

An index builder 106 can include one or more program modules that build an index such as index 112 as part of processing the database query 110. Index builder 106 can include one or more modules that measure actual resource usage, represented in FIG. 1b by measuring module 106a. Measuring module 106a can measure actual resource usage by parallel processing units and can generate a baseline resource utilization for the specified number of initial parallel processing units that complete. Index builder 106 can include one or more modules that calculate the baseline resource utilization, represented in FIG. 1b by measuring module 106a. Measuring module 106a can measure resource usage of each parallel processing unit when it completes and can update a current baseline resource utilization using a computation derived from actual resource utilization, represented in FIG. 1b by baseline 120. Index 112 can be a rowstore index, a columnstore index or any other kind of index. Results such as results 114 can be returned. Results 114 can be displayed on a display device of a computing device, or can be presented in report form or in any suitable way.

In operation a query such as database query 110 can be received. A non-limiting example of a query may be a “CREATE COLUMNSTORE INDEX” statement for a row-mode index build, or can be any query for which parallel processing is desired. The database engine such as database engine 104 can receive the query and can create an index plan such as index plan 121 for the query. An index builder such as index builder 106 can receive the index plan 121. Index builder 106 can receive information (e.g., segment definition 122) that defines a segment of the index that is to be built by a parallel processing unit. Segment definition 122 can be received by user input, by a value stored with database 108, by a value stored with index builder 106 or by any other means. In accordance with some aspects of the subject matter described herein the index builder 106 can change the segment definition in accordance with rules provided for the segment definition with respect to the degree of parallelism achievable with that segment definition.

Index builder 106 can begin to create an index such as index 112. Index 112 can include one or more index segments, represented in FIG. 1b by index segments such as segment 1 112a, segment 2 112b . . . segment n 112n. Index builder 106 can reserve resources (e.g., reserved memory 116) for building the index. The amount/number of resources reserved can be the maximum allowed resources per query. For example, the amount of memory that is reserved can be the maximum allowed memory per query. The maximum amount/number of resources that can be reserved can be determined by a configurable setting for the computing device, by a user-defined amount of resources, by a computation derived from the amount of resources of the computing device or by any other method. A specified number of initial parallel processing units can be activated. Suppose the specified number of initial parallel processing units is one. A single parallel processing unit such as parallel processing unit 118a (e.g., a single thread) can be activated. Parallel processing unit 118a can generate a segment of an index. In the event that parallel processing unit 118a starts to run low on memory (i.e., an out-of-memory condition occurs or is likely to occur), all or some additional memory of reserved memory 116 can be provided to parallel processing unit 118a. It will be appreciated that although the initial number of parallel processing units activated in this example is one, any number of initial parallel processing units can be activated to determine the initial baseline resource utilization.

The actual amount of resources (e.g., memory) that are used by parallel processing unit 118a can be measured by one or more program modules, represented in FIG. 1b by measuring module 106a. The actual amount/number of resources that are used by parallel processing unit 118a can be used to determine a baseline (e.g., an initial baseline) of resource utilization for future parallel processing units. The baseline resource utilization can be updated by the measuring module 106a when other parallel processing units complete. The updated baseline resource utilization can be used to determine how many additional parallel processing units are activated. For example, the actual amount of memory that is used by the first parallel processing unit, parallel processing unit 118a can be used to determine a baseline of memory usage for future parallel processing units (e.g., parallel processing unit 118b, . . . parallel processing unit 118n). Additional activated parallel processing units (e.g., parallel processing unit 118b, . . . parallel processing unit 118n can be activated and can generate additional index segments such as index segment 2 112b . . . index segment n 112n.

The computation used to determine the current baseline resource utilization can be a simple average, a weighted average or any other computation from which the current baseline resource utilization is derived. The process described above can continue until the entire index has been built. After the index has been built, the database engine 104 can complete processing the query and return the requested results 114 (e.g., a “success” code).

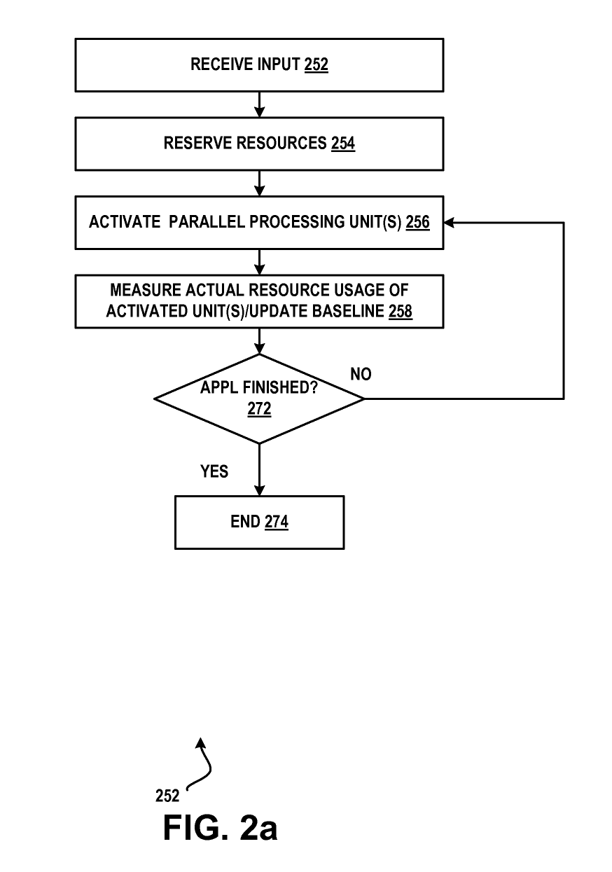

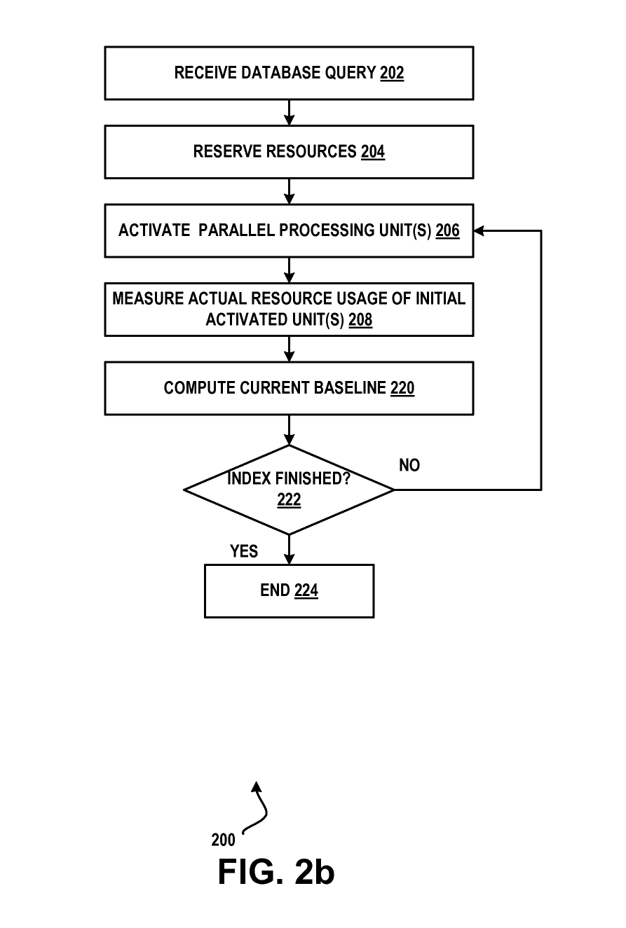

FIG. 2a illustrates an example of a method 250 that dynamically adjusts the degree of parallelism employed for executing an application in accordance with aspects of the subject matter disclosed herein. The method described in FIG. 2a can be practiced by a system such as but not limited to the one described with respect to FIG. 1a. While method 250 describes a series of operations that are performed in a sequence, it is to be understood that method 250 is not limited by the order of the sequence. For instance, some operations may occur in a different order than that described. In addition, one operation may occur concurrently with another operation. In some instances, not all operations described are performed.

At operation 252 an application can be initiated. Input to the application can be received. Input to the application can include data, such as but not limited to a definition of how the application can be broken into portions that can be executed by parallel processing units. Input to the application can include data, such as but not limited to a number of parallel processing units to activate initially to determine an initial baseline resource utilization. Input can include a computation that is used to determine how many parallel processing units are activated initially. Input can include an estimate of baseline resource utilization. The number of parallel processing units to activate initially can be pre-determined or hardcoded into the application. Input can include a portion or segment definition that defines output generated by a parallel processing unit. At operation 254 resources can be reserved. The reserved resources can be a maximum amount/number of resources that can be allocated per application in preparation for a maximum degree of parallel processing of the application. Resources can include memory, CPU resources or any other resources needed by the application.

The first time operation 256 is performed the specified number of initial parallel processing units can be activated. The number of initially-activated parallel processing units can be based on an initial baseline resource utilization. The initial baseline resource utilization can be an estimate of resource utilization that is provided in input or computed. The activated parallel processing unit(s) can be used to create a specified portion of the result. The portion of the application processed by the activated parallel processing unit(s) can be a configurable portion of results. The portion of the application executed by each activated parallel processing unit can be determined by any suitable means. The activated parallel processing unit(s) can be allowed to use all or some of the reserved resources. The activated parallel processing unit(s) can be allowed to use all or some of the reserved memory so that an out-of-memory condition becomes unlikely. The actual resource usage of a parallel processing unit can be measured when a parallel processing unit completes execution. At operation 258 the actual usage of resources by a parallel processing unit that has completed execution can be measured. The actual resource utilization measurement can be used to refine the baseline resource utilization per parallel processing unit. The updated baseline resource utilization thus comprises a current baseline resource utilization.

The current baseline resource utilization can be calculated by averaging in the new actual resource usage, by computing a simple average, by computing a weighted average or by using any computation to compute a current baseline resource utilization. Processing can return to operation 256. Using the updated baseline resource utilization, an additional number of parallel processing units that can be supported by the reserved resources can be computed. The activate, measure and update/re-compute paradigm can be continued until the application finishes. At operation 272, if the application is complete, processing can end at operation 274. At operation 272 if the application is not complete, processing can continue at operation 256. The degree of parallelism employed in executing of the application can thus react to non-uniform data distribution by increasing or decreasing the degree of parallelism (i.e., the number of activated parallel processing units) during the execution of the application. Each parallel processing unit can run without affecting any other parallel processing units.

FIG. 2b illustrates an example of a method 200 that dynamically adjusts the degree of parallelism employed for building an index for a database in accordance with aspects of the subject matter disclosed herein. The method described in FIG. 2b can be practiced by a system such as but not limited to the one described with respect to FIG. 1b. While method 200 describes a series of operations that are performed in a sequence, it is to be understood that method 200 is not limited by the order of the sequence. For instance, some operations may occur in a different order than that described. In addition, one operation may occur concurrently with another operation. In some instances, not all operations described are performed.

At operation 202 a database query as described above can be received. Additional input can also be received including but not limited to an estimate of resources needed by a parallel processing unit, a description of a segment of an index to be created, etc., as described more fully above. At operation 204 a portion of available resources can be reserved. For example, at operation 204 a portion of memory can be reserved. The reserved resources can be a maximum amount/number of resources that can be allocated per query in preparation for a maximum degree of parallel processing of the index.

The first time operation 206 is executed, a specified number of initial parallel processing units can be activated based on an initial baseline resource utilization. The initial baseline resource utilization can be an estimate, or can be based on a calculation performed by an application. The initial baseline resource utilization can be based on actual usage of resources of the first parallel processing unit to complete execution. The activated parallel processing unit(s) can be used to build one or more segments of the index. The segment built by an activated parallel processing unit can be the segment of the index for a configurable number of rows (e.g., the index for a million rows). The segment built by an activated parallel processing unit can be the segment of the index for some other specifiable portion of the database. The activated parallel processing unit(s) can be allowed to use all or some of the reserved resources. For example an activated parallel processing unit can be allowed to use all or some portion of reserved memory so that an out-of-memory condition becomes unlikely. At operation 208 the actual usage of resources can be measured. Using the actual measurement of resources used by a parallel processing unit that has completed execution, the baseline resource utilization (used to determine how many parallel processing units the reserved resources can support) can be updated at operation 220. A number of parallel processing units that the reserved resources can support can be calculated based on the updated baseline resource utilization. A number of parallel processing units to activate can be determined based on the calculation. That is, the number of parallel processing units activated can be determined by a computation derived from the updated (current) baseline resource utilization. The current baseline resource utilization can be computed using any suitable computation (e.g., weighted average, simple average or any other algorithm).

Processing can return to operation 206. The activate, measure and update/ re-compute paradigm can be continued until the building of the index is completed. At operation 222, if the index is complete, processing can end at operation 224. At operation 222 if the index is not complete, processing can continue at operation 206. Building of the index can thus react to non-uniform data distribution by increasing or decreasing the degree of parallelism (i.e., the number of activated parallel processing units) during the creation of the index. Each parallel processing unit can run without affecting any other parallel processing units.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor: and a module that when loaded into the memory causes the at least one processor to:
adjust a degree of parallel processing employed in executing an application while the application is miming by:
reserving resources for parallel processing;
activating an initial number of parallel processing units based on an initial baseline resource utilization;
measuring actual resources used by each of the activated parallel processing units;
updating the initial baseline resource utilization using a computation derived from the actual resources used, generating a current baseline resource utilization; and
determine a number of additional parallel processing units to activate based on the current baseline resource utilization.

2. The system of claim 1, further comprising:
a module that when loaded into the memory causes the at least one processor to:
reserve resources for parallel processing, the reserved resources comprising memory, I/O or CPU time.

3. The system of claim 1, further comprising:
a module that when loaded into the memory causes the at least one processor to:
repeat until the application completes:
the measuring of actual resources used by each of the activated parallel processing units;
the updating of the current baseline resource utilization using a computation derived from the measured actual resources used; and
the determining of the number of additional parallel processing units to activate based on the current baseline resource utilization.

4. The system of claim 1, wherein the reserved resources comprise a maximum allowed for the application, a user-defined amount of resources or a computed amount of resources.

5. The system of claim 4, wherein the maximum amount of resources allowed for the application is determined by a configurable setting for the computing device, a user-defined amount of resources, or by a computation derived from an amount of resources available to a computing device executing the application.

6. The system of claim 1, wherein a degree of parallelism employed in executing the application reacts to non-uniform data distribution by increasing or decreasing the degree of parallelism.

7. The system of claim 1, wherein the application is an index building application for a database management system.

8. A method of dynamically adjusting degree of parallelism comprising:
in response to receiving a database query; reserving resources for parallel processing;
activating a first parallel processing unit, the first parallel processing unit building a first segment of an index associated with the database query;
when the first parallel processing unit completes execution, measuring an amount of actual resources consumed by the single parallel processing unit, the actual amount of resources consumed comprising a baseline resource utilization;
using the baseline resource utilization, determining a number of parallel processing units to activate;
activating a plurality of parallel processing units, the plurality of parallel processing units comprising the determined number of parallel processing units;
upon completion of execution of a parallel processing unit of the plurality of parallel processing units, the parallel processing unit of the plurality of parallel processing units comprising a second parallel processing unit, the second parallel processing unit building a second segment of the index, measuring actual resources consumed by the second parallel processing unit of the plurality of processing units;
updating the baseline resource utilization according to a computation derived from the actual resources used by the first parallel processing unit and the actual resources used by the second parallel processing unit;
using the updated baseline resource utilization to determine a number of parallel processing units to activate.

9. The method of claim 8, further comprising:
repeating until the index is complete by:
when a parallel processing unit of the plurality of parallel processing unit completes execution, measuring actual resources consumed by the completed parallel processing unit;
updating the baseline resource utilization according to a computation derived from the completed parallel processing unit; and
using the updated baseline resource utilization to determine a number of parallel processing units to activate.

10. The method of claim 8, wherein a segment of the index built by a parallel processing unit comprises a segment of the index for a configured number of rows of the database.

11. The method of claim 8, wherein a degree of parallelism employed in execution of the query adjusts to changing resource availability.

12. The method of claim 8, wherein a degree of parallelism employed in execution of the query adjusts to changing characteristics of data in the database.

13. The method of claim 8, further comprising;
enabling an activated parallel processing unit to use all or part of the reserved resources, the reserved resources comprising memory.

14. A computer-readable storage medium comprising computer-readable instructions which when executed cause at least one processor of a computing device to:
activate a specified number of initial parallel processing units;
measure resources used by the activated parallel processing units to determine a baseline resource utilization; and
determine a number of additional parallel processing to activate based on the baseline resource utilization.

15. The computer-readable storage medium of claim 14, comprising further computer-readable instructions which when executed cause the at least one processor to:
update the baseline resource utilization to create a current baseline resource utilization by measuring actual resource utilization of completed parallel processing units.

16. The computer-readable storage medium of claim 15, comprising further computer-readable instructions which when executed cause the at least one processor to:
activate additional parallel processing units based on the current baseline resource utilization.

17. The computer-readable storage medium of claim 14, comprising further computer-readable instructions which when executed cause the at least one processor to:
update the baseline resource utilization using an algorithm comprising a weighted average or a simple average.

18. The computer-readable storage medium of claim 17, comprising further computer-readable instructions which when executed cause the at least one processor to:
measure actual resource utilization of the first parallel processing unit.

19. The computer-readable storage medium of claim 18, comprising further computer-readable instructions which when executed cause the at least one processor to:
compute an initial baseline resource utilization from the actual resource utilization of the first parallel processing unit.

20. The computer-readable storage medium of claim 14, comprising further computer-readable instructions which when executed cause the at least one processor to:
create an index for a database.
